(19) United States
(12) Patent Application Publication
(10) Pub. No.: US 2019/0220058 A1
(43) Pub. Date: Jul. 18, 2019

(54) Protective slot for notebook computers

(71) Applicant: Yubo LIU, Changsha (CN)

(72) Inventor: Yubo LIU, Changsha (CN)

(21) Appl. No.: 15/871,140

(22) Filed: Jan. 15, 2018

(51) Int. Cl. G06F 1/16; A45F 3/04; A45C 11/00; A45C 13/02

(52) U.S. Cl. CPC G06F 1/1628; A45F 3/04; A45C 11/00; A45C 2013/025; A45C 2011/003; A45C 2013/026; A45C 13/02

(57) ABSTRACT

A protective slot for protecting a notebook computer, having at least one inner component and an outer component; the outer component is placed inside a backpack, and the at least one inner component is nested inside the outer component; the at least one inner component and the outer component each has at least one open-type cavity for buffering; when the at least one inner component is nested into the outer component, at least one closed-type cavity is formed at the outer component for buffering.

### BACKGROUND OF THE INVENTION

The present invention relates to a protective slot for notebook computers.

Some backpacks currently available in the market are designed with inner pockets for storing notebook computers. However, most of these inner pockets are made as fabric products which may only serve the purpose of spatial separation and prevent rocking of the notebook computer. These inner pockets are far from enough to protect the notebook computers from damages caused by impact or falling off to the ground. Moreover, there are still many backpacks without any interlayers or inner pockets for storing notebook computers. As the use of notebook computers has become more common, the notebook computers may be easily damaged by vigorous rocking, impact or accidental fall-off if they are stored unprotected in these backpacks without interlayers or inner pockets.

In view of the aforesaid disadvantages, the prior arts provide the following common solutions:

Thickened bottom: protective effect is achieved by using thicker materials or using added fillings. However, a thickness of the added fillings is limited, and a choice of materials is also limited.

Suspended inner pocket: a bottom side of the inner pocket is suspended from and does not directly touch the bottom of the backpack to provide some kind of buffering.

Thickened walls of the inner pocket: walls of the inner pockets are thickened by added filings. In this situation, a notebook computer is most likely to be damaged inside the backpack when the backpack falls off, resulting in two corners and a side edge of the notebook computer proximal to the bottom of the backpack to be impacted vigorously, thereby damaging the notebook computer.

The above solutions provide very limited protective effects and cannot effectively protect the notebook computer, particularly when the backpack carries just a few items, or when the backpack falls off from a great height and/or under a fast speed, or when the backpack is impacted by hard objects.

### BRIEF SUMMARY OF THE INVENTION

In view of the aforesaid disadvantages, the present invention provides the following technical solution.

A protective slot for protecting a notebook computer, comprising at least one inner component and an outer component; the outer component is placed inside a backpack, and the at least one inner component is nested inside the outer component; the at least one inner component and the outer component each comprises at least one open-type cavity for buffering; when the at least one inner component is nested into the outer component, the outer component is formed with at least one closed-type cavity for buffering.

Further, the at least one inner component covers side surfaces of the notebook computer; one side of the at least one inner component is a slot surrounding the side surfaces of the notebook computer; another opposite side of the at least one inner component is a buffering surface having a flat or a curved shape.

Further, the outer component covers the at least one inner component; one side of the outer component is a slot covering the at least one inner component; another opposite side of the outer component is an impact surface having a wavy or a curved shape.

Further, the impact surface of the outer component has an irregular curved shape or a regular curved shape; an inner side surface of the slot of the outer component also has a corresponding wavy or curved shape.

Further, when the buffering surface of the at least one inner component and the impact surface of the outer component have curved shapes, a curved shape of an outer side of the buffering surface is different from a curved shape of an outer side of the impact surface.

Further, the protective slot is made of ethylene-vinyl acetate (EVA), thermoplastic elastomer (TPE) or thermoplastic rubber (TPR) materials which are ductile, resilient and sturdy; each of the at least one inner component and the outer component is made of one of EVA, TPE and TPR.

Further, when the at least one inner component is nested within the outer component, the at least one closed-type cavity is defined by contact between the buffering surface and an inner side of the impact surface.

A size of the at least one closed-type cavity is determined by curvature of the impact surface or the buffering surface; a quantity of the at least one closed-type cavity is determined by a number of curved surfaces on the impact surface or on the buffering surface.

Further, an opening of the slot of the outer component is provided with a plurality of adjustment holes for installing or taking out the at least one inner component; the adjustment holes adjust a size of the opening of the slot of the outer component.

Compared with the prior art, the present invention has the following beneficial effect: the present invention is very safe.

### BRIEF DESCRIPTION OF THE DRAWINGS

FIG. 1 is a structural view of the protective slot according to the present invention.

FIGS. 2A and 2B illustrate different structures of the outer component in different embodiments.

FIG. 3 is a schematic view illustrating a condition where the inner components are to be inserted into the outer component.

FIG. 4 shows another embodiment in which an inner component is inserted into an outer component.

### DETAILED DESCRIPTION OF THE INVENTION

The technical solution according to an embodiment of the present invention will be clearly and completely described below with reference to the drawings. Obviously, the embodiment to be described is only one of the embodiments of the present invention and does not include all possible ways of implementing the present invention. Any other embodiments obtainable based on the embodiment described herein by a person skilled in this field of art without any inventive efforts should also fall within the scope of protection of the present invention.

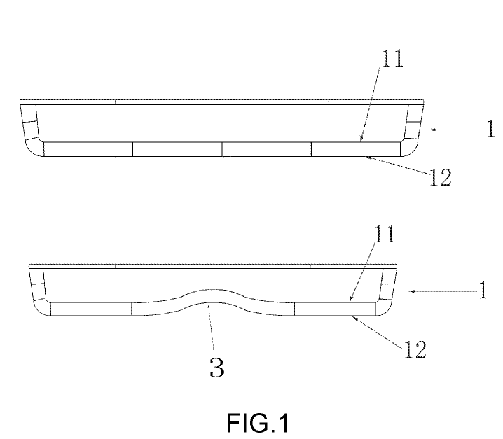

As shown in FIGS. 1-4, a protective slot for protecting a notebook computer is shown comprising a plurality of inner components (generally indicated by reference 1, and more specifically indicated by 1a, 1b, 1c to refer to a plural number of inner components) and an outer component 2; the outer component 2 is placed inside a backpack, and the inner components 1 are nested inside the outer component 2. When the inner components 1 are nested into the outer component 2, at least one cavity (generally indicated by reference 3) is formed.

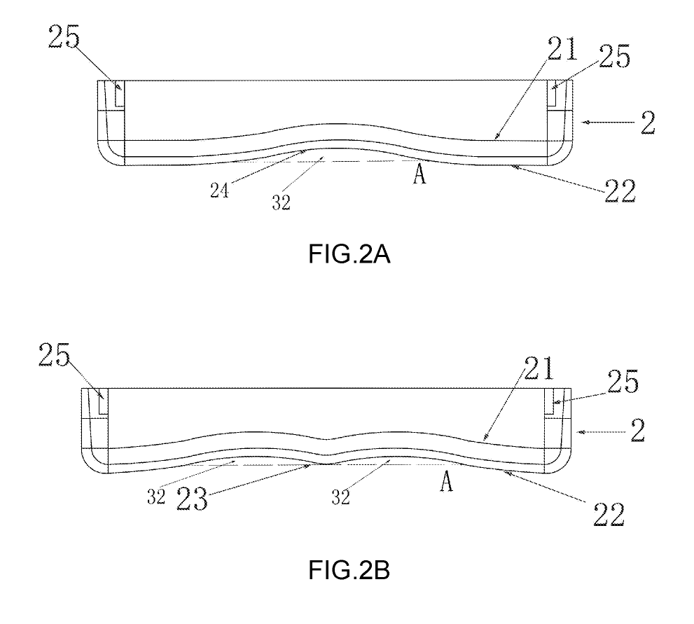

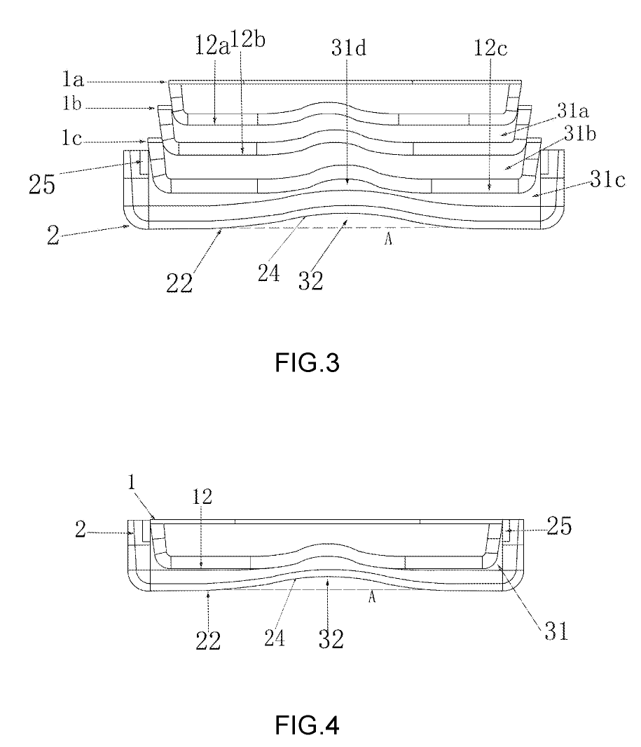

The at least one cavity 3 is either a closed-type cavity (generally indicated by reference 31, and more specifically indicated by 31a, 31b, 31c, 31d to refer to a plural number of closed-type cavities) or an open-type cavity 32. Either type of the at least one cavity 3 has the same buffering effect. Within the outer component, the closed-type cavity 31 is formed by a curved surface of a slot 21 of the outer component being closed by the inner components. The at least one open-type cavity 32 is an inwardly curved recess formed by a curved wall surface 24 of an impact surface 22 of the outer component 2. As shown in FIGS. 3 and 4, a space enclosed by the curved wall surface 24 and a dotted line A is one of said at least one open-type cavity. Dotted line A is not part of the product as claimed. It is only shown in FIGS. 2-4 with a view to better illustrating the open-type cavity. When the inner components are nested inside the outer component, some of the at least one open-type cavity is closed by the inner components, thereby forming the at least one closed-type cavity. The at least one cavity 3 can protect the notebook computer effectively when the notebook computer hits a hard object or falls off from a greater height. When the inner components are not nested within the outer component, the at least one cavity 3 of the inner components and the outer component is said at least one open-type cavity. Only when the inner components are nested within the outer component, said at least one closed-type cavity is formed.

In the present embodiment, the inner components 1 have different dimensions. An inner component 1a having the smallest dimension can be nested inside another inner component 1b having a second smallest dimension, so on and so forth. Accordingly, an inner component 1c having the largest dimension is nested inside the outer component 2. Outer shapes of each and every inner components 1 are different, so that a larger quantity of the at least one cavity 3 can be formed.

The inner components 1 and the outer component 2 can be used individually, or can be used in combination. Two inner components can also be used. Various combinations of use are available and will not be completely listed herein.

The inner components 1 are used for covering side surfaces of the notebook computer; one side of each inner component is a slot 11 surrounding the side surfaces of the notebook computer; another opposite side of each inner component is a buffering surface 12, 12a, 12b, 12c having a flat or a curved shape.

The outer component 2 is used for covering the inner components 1. One side of the outer component 2 is a slot 21 used for covering the inner components; another opposite side of the outer component 2 is an impact surface 22 having a wavy or a curved shape. The wavy or curved shape of the impact surface 22 can effectively reduce impact force and vibration when the notebook computer is subject to impact.

As shown in FIGS. 2A and 2B, the impact surface 22 of the outer component has an irregular curved shape 23 comprising a wavy line or a regular curved shape 24 comprising a curve. In FIG. 2B, when the impact surface 22 of the outer component has the irregular curved shape 23, the wavy line of the irregular curved shape comprises two curves; two curved surfaces formed by the two curves form two open-type cavities 32 together with the dotted line A; if the wavy line of the irregular curved shape comprises more curves, more open-type cavities 32 can be formed; in FIG. 2A, when the impact surface 22 of the outer component has a regular curved shape comprising a curve, there is only one curved surface, which forms one open-type cavity 32 together with the dotted line A; an inner side surface of the slot 21 also has a corresponding irregular curved shape comprising wavy lines or a regular curved shape comprising a curve. A product to be protected determines which shape is to be used. For example, irregular curved shape should be used for fragile products since more open-type cavities can be formed.

As shown in FIG. 3, when the buffering surface 12 of each inner component and the impact surface 22 of the outer component have curved shapes, the curved shape of an outer side of the buffering surface 12 is different from the curved shape of an outer side of the impact surface 22. Combinations of different curved shapes during use create larger cavity for better protection of the notebook computer when it is subject to impact.

The protective slot of the invention is made of Ethylene-vinyl acetate (EVA), thermoplastic elastomer (TPE) or thermoplastic rubber (TPR) materials which are ductile, resilient and sturdy. Each of the inner components and the outer component is made of one of EVA, TPE and TPR. EVA material is highly resilient, ductile and tensile, and good at anti-shocking and buffering. TPE material is safe, non-toxic, environmental friendly and soft, and it is highly industrial since it does not require sulfurization and can be recycled to reduce costs and can be subject to secondary operation of injection molding. TPR material has the resilience of rubber and it is also anti-abrasive, anti-slippery and shock reducing.

As shown in FIG. 4, when the inner components 1 are nested within the outer component 2, the closed-type cavity 31 is defined by contact between the buffering surface 12 and an inner side of the impact surface 22.

A size of the at least one cavity 30 is determined by curvature of the impact surface 22 or the buffering surface 12; a quantity of the at least one cavity 30 is determined by a number of curved surfaces on the impact surface 22 or the buffering surface 12. During impact, the notebook computer will be subject to lesser impact when there are more cavities and when the cavities have larger sizes.

As shown in FIGS. 2-4, an opening of the slot 21 of the outer component 2 is provided with a plurality of adjustment holes 25 for installing or taking out the inner components. The adjustment holes 25 are used for adjusting a size of the opening of the slot 21 of the outer component 2. The adjustment holes 25 enable the inner components 1 to be more quickly and easily inserted into and separated from the outer component 2.

Although an embodiment of the present invention is shown and described above, it is obvious to a person skilled in this field of art that the disclosed embodiment can be subject to various changes, modifications, replacements and variations without deviating from the concept and essence of the present invention. The scope of the present invention is defined by the appended claims and their equivalents.

What is claimed is:

1. A protective slot for protecting a notebook computer, comprising at least one inner component and an outer component; the outer component is placed inside a backpack, and the at least one inner component is nested inside the outer component; the at least one inner component and the outer component each comprises at least one open-type cavity for buffering; when the at least one inner component is nested into the outer component, the outer component is formed with at least one closed-type cavity for buffering.

2. The protective slot of claim 1, wherein the at least one inner component covers side surfaces of the notebook computer; one side of the at least one inner component is a slot surrounding the side surfaces of the notebook computer; another opposite side of the at least one inner component is a buffering surface having a flat or a curved shape.

3. The protective slot of claim 1, wherein the outer component covers the at least one inner component; one side of the outer component is a slot covering the at least one inner component; another opposite side of the outer component is an impact surface having a wavy or a curved shape.

4. The protective slot of claim 3, wherein the impact surface of the outer component has an irregular curved shape or a regular curved shape; an inner side surface of the slot of the outer component also has a corresponding wavy or curved shape.

5. The protective slot of claim 1, wherein when the buffering surface of the at least one inner component and the impact surface of the outer component have curved shapes, a curved shape of an outer side of the buffering surface is different from a curved shape of an outer side of the impact surface.

6. The protective slot of claim 1, wherein the protective slot is made of ethylene-vinyl acetate (EVA), thermoplastic elastomer (TPE) or thermoplastic rubber (TPR) materials which are ductile, resilient and sturdy; each of the at least one inner component and the outer component is made of one of EVA, TPE and TPR.

7. The protective slot of claim 6, wherein each of the at least one inner component and the outer component is made of one of EVA, TPE and TPR.

8. The protective slot of claim 1, wherein when the at least one inner component is nested within the outer component, the at least one closed-type cavity is defined by contact between the buffering surface and an inner side of the impact surface.

9. The protective slot of claim 8, wherein a size of the at least one closed-type cavity is determined by curvature of the impact surface or the buffering surface; a quantity of the at least one closed-type cavity is determined by a number of curved surfaces on the impact surface or on the buffering surface.

10. The protective slot of claim 1, wherein an opening of the slot of the outer component is provided with a plurality of adjustment holes for installing or taking out the at least one inner component; the adjustment holes adjust a size of the opening of the slot of the outer component.
